(19) United States
(12) Patent Application Publication
(10) Pub. No.: US 2007/0107003 A1
(43) Pub. Date: May 10, 2007

(54) Apparatus for loading CD

(76) Inventors: Chin-Sung Liu, Hsinchu (TW); Chia-Hao Ou, TaiChung Hsien (TW)

Correspondence Address: LIN & ASSOCIATES INTELLECTUAL PROPERTY, P.O. BOX 2339, SARATOGA, CA, 95070-0339, US

(21) Appl. No.: 11/377,823

(22) Filed: Mar. 16, 2006

(30) Foreign Application Priority Data
Nov. 4, 2005 (TW) 094219118

(51) Int. Cl. G11B 17/04

(52) U.S. Cl. 720/604

(57) ABSTRACT

A CD player loading apparatus is provided, including a tray, a base, and a clipping set. The clipping set includes two fixed clipping element and a moveable clipping element. The tray is located at the top part of the base for loading and ejecting the CD. The tray is shortened so that the clipping set is used to compensate the original loading stability. The shortened tray hides inside the base during loading and ejecting the CD. Therefore, the clipping set clips to hold the CD when the CD enters the base, and moves the CD to the correct position for data access. The fixed clipping elements are located on the tray and the moveable clipping element is on the front part of the base. The moveable clipping element turns along the edge of the CD when the CD loads or ejects the CD from the base.

### FIELD OF THE INVENTION

The present invention generally relates to a CD loading apparatus, and more specifically to an apparatus for clipping and holding CD.

### BACKGROUND OF THE INVENTION

The conventional CD players are divided into two types according to the use of loading mechanism. The first type is called tray type, and the second is called slot-in type.

The tray CD player uses a loading tray at the base of the player. The tray can slide out from the base when operated. After the disc is placed on the tray, the tray can slide into the base with the press of a control button or a direct slight nudge at the front edge of the tray. Then, the suppresser device inside the base drags the tray and drives the rotation of the disc. The read-write device reads data from or writes data to the disc. This type of tray CD player has a simple structure, and therefore is less expensive to manufacture. However, because the tray becomes a suspending arm after sliding out from the base, the tray is prone to breakage if accidentally smashed or collided with heavier objects. This becomes a major disadvantage for the tray CD player.

On the other hand, the slot-in CD player uses a design without a tray. The main structure of a slot-in CD player is the complicated mechanical structure inside the base. After the disc is inserted into the slot, the sensor senses the disc and activates the complicated link mechanism to pick up the disc and transfer the disc to a specific position. The suppressor device suppresses the disc and the read-write device reads or writes data. The slot-in CD player has the disadvantage of having a complicated structure and, therefore, is expensive to manufacture.

Although the tray CD is simple in structure and inexpensive to manufacture, the disadvantage of breakage in the tray is a major problem. On the other hand, although the slot-in CD player does not have the disadvantage of a suspending and breakable tray, the structure of the slot-in CD player is complicated and is expensive to manufacture. Therefore, it is important to provide a CD player that has the advantages of both types without the disadvantages.

### SUMMARY OF THE INVENTION

The present invention has been made to overcome the above-mentioned respective drawbacks of conventional tray CD player and slot-in CD player. The primary object of the present invention is to provide a CD player loading apparatus that is simple in structure and inexpensive to manufacture.

To achieve the above object, the present invention provides a structure of clipping and fixation of a CD player loading apparatus, including a tray, a base, and a clipping set. The clipping set includes two fixed clipping element and a moveable clipping element. The tray is located at the top part of the base for loading and ejecting the CD. The tray is shortened so that the clipping set is used to compensate the original loading stability. The shortened tray hides inside the base during loading and ejecting the CD. Therefore, the clipping set clips to hold the CD when the CD enters the base, and moves the CD to the correct position for data access.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the relative position of each element in the loading apparatus of the present invention;

FIG. 2 shows a schematic view of the relative position of the moveable clipping element and the CD just loaded;

FIG. 3 shows a schematic view of the relative position of the moveable clipping element and the CD entering the base;

FIG. 3A shows a schematic view of the relative position of the moveable clipping element and the CD entered the base entirely; and

FIG. 4 shows a schematic view of the relative position of the moveable clipping element and the CD ejected from the base.

### DETAILED DESCRIPTION OF THE PREFERRED EMBODIMENTS

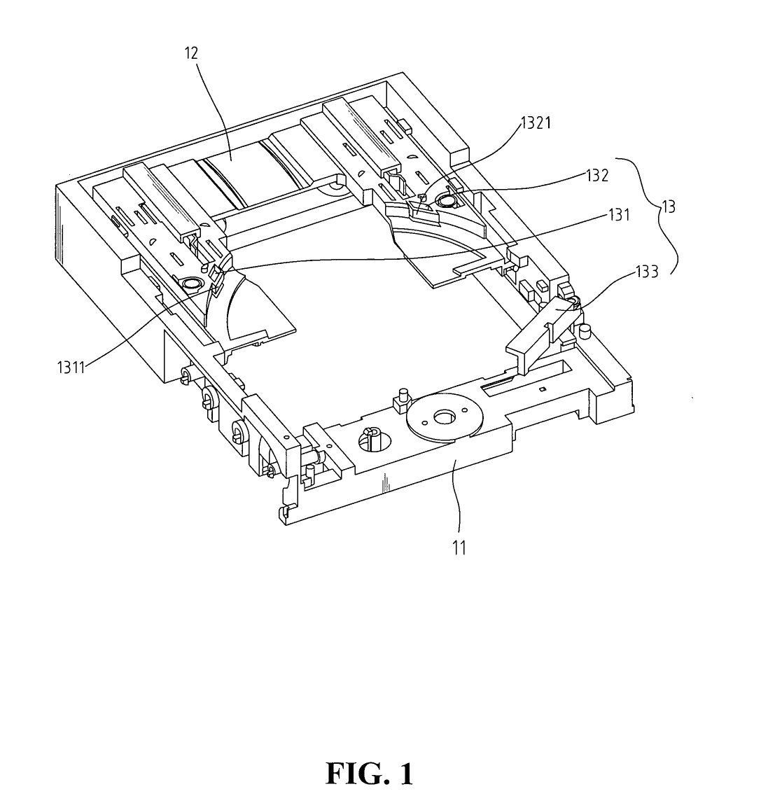

FIG. 1 shows a schematic view of the relative position of each element in the loading apparatus of the present invention. The loading apparatus includes a base 11, a tray 12, and a clipping set 13. Clipping set 13 further includes two fixed clipping element 131, 132 and a moveable clipping element 133.

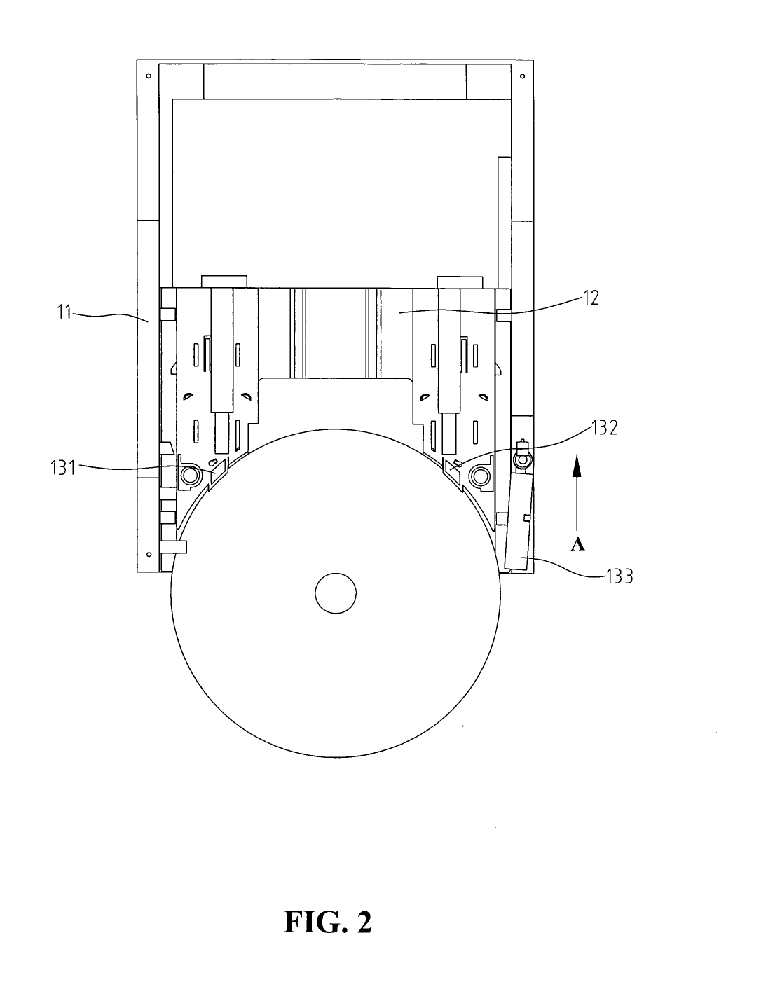

Tray 12 is located at the top part of base 11, and can move inside base 11 along a straight track. A CD is loaded to tray 12 as shown in FIG. 1 for showing the operation and relative position during loading and ejecting a CD. FIGS. 2-4 show an embodiment of the relative positions during loading and ejecting a CD.

Clipping set 13 is for loading and holding the CD. Fixed clipping elements 131, 132 are the symmetric parallel trench at the front end of tray 12 and are an integrated part of tray 12. Fixed clipping elements 131, 132 have an opening 1311, 1321. For precisely clipping the CD, openings 1311, 1321 have a thickness of 1.2 mm, which is also the thickness of the CD. Moveable clipping element 133 is for holding the CD, and is designed as a moveable hanging arm. Moveable clipping element 133 is located the front part of base 11 and is connected to tray 12. The lower part of moveable clipping element 133 includes a spring element (not shown) for changing the angles of moveable clipping element 133 when affected by the movement of tray 12.

FIG. 2 shows a schematic view of the relative position of the moveable clipping element and the CD just loaded on the tray. The CD is placed on tray 12 in the direction parallel to base 11. The central hole of the CD stays outside of base 11. Fixed clipping elements 131, 132 above tray 12 clip the front part of the CD. The design of keeping the central hole outside of the base lowers the possibility that the user scratches the protective film of the CD when loading and ejecting the CD.

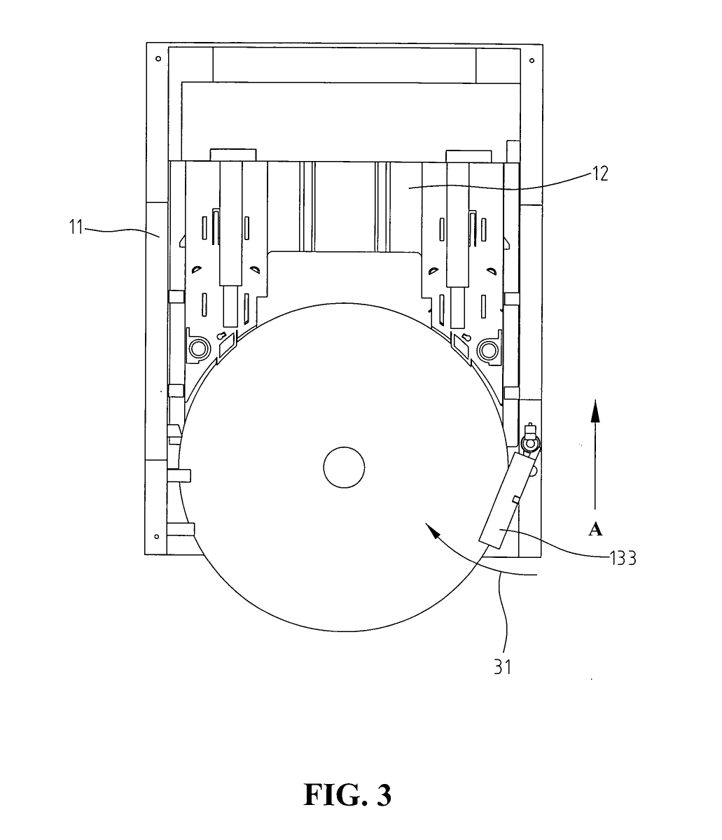

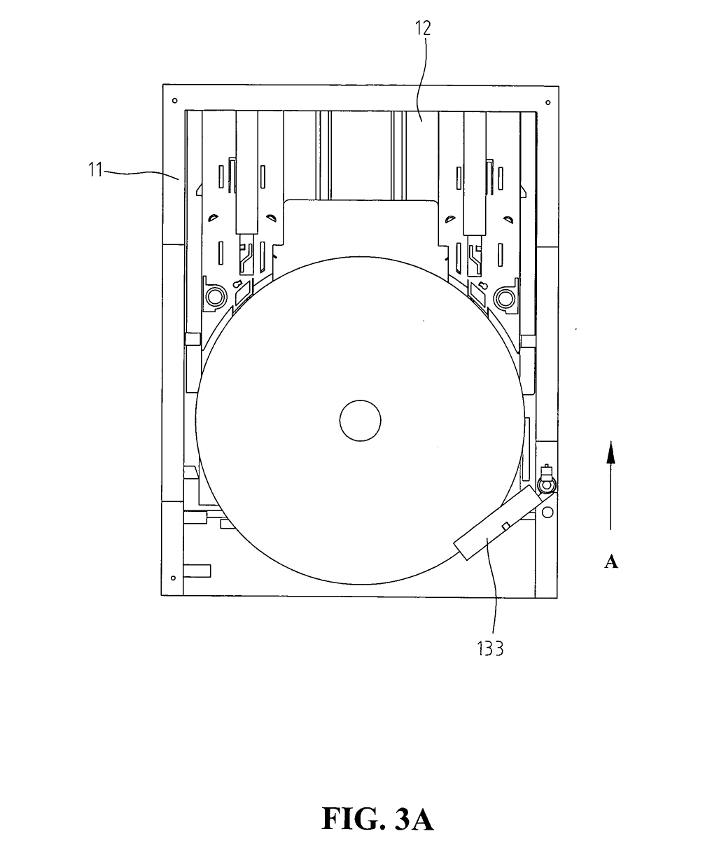

FIG. 3 shows a schematic view of the relative position of the moveable clipping element and the CD entering the base. As shown in FIG. 3, when a small push force is applied to the CD outside of base 11, tray 12 moves towards the direction marked as arrow A. Moveable clipping element 133 moves along the edge of the CD and turns towards the direction 31.

FIG. 3A shows a schematic view of the relative position of the moveable clipping element and the CD entered the base entirely. When tray 12 moves along direction A and reaches the end of base 11, the loading process is complete, and the CD is ready for data access. Moveable clipping element 133 stops its movement as the loading process terminates. Moveable clipping element 133 stays against the edge of the CD to provide further support and prevent the CD from bouncing out.

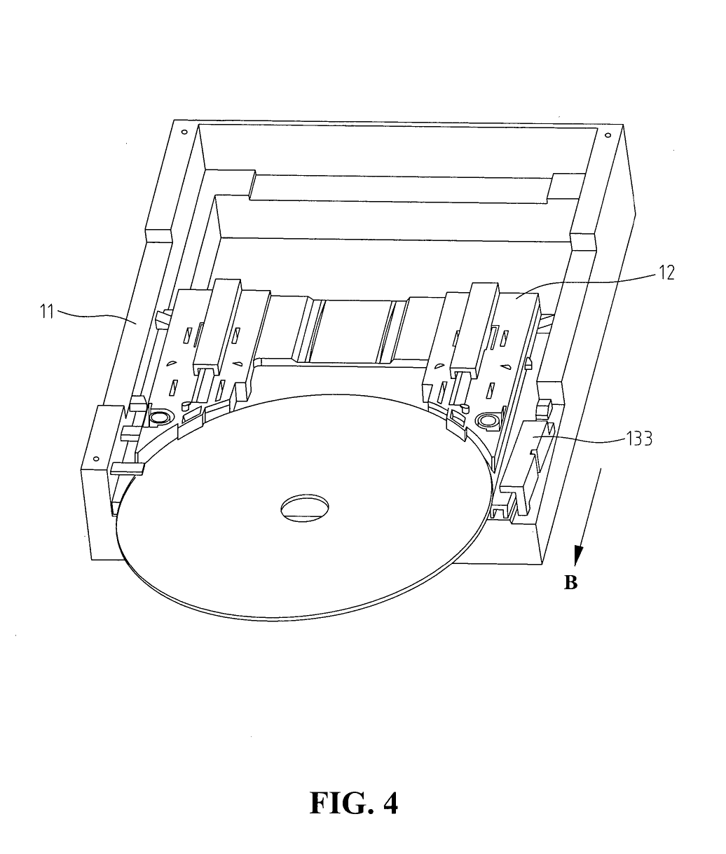

FIG. 4 shows a schematic view of the relative position of the moveable clipping element and the CD ejected from the base. When the accesses to the CD finish and the CD is ejected, tray 12 moves towards the direction B. When tray reaches the front end of base 11, the CD is outside of base 11. Due to the movement of tray 12, moveable clipping element 133 is pushed aside to the position as in FIG. 1.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A CD loading apparatus, comprising:
a tray, for loading CD;
a base, for housing said tray for loading CD; and
a clipping set, for clipping and fixing said CD, further including:
at least two fixed clipping elements; and
at least a moveable clipping element.

2. The CD loading apparatus as claimed in claim 1, wherein said tray is housed inside said base and moves inside said base along a straight track.

3. The CD loading apparatus as claimed in claim 1, wherein said tray is shorter than ⅔ of a 12-cm CD.

4. The CD loading apparatus as claimed in claim 1, wherein said clipping set clips at points that are on the same horizontal or vertical plane.

5. The CD loading apparatus as claimed in claim 1, wherein said fixed clipping elements are located on said tray, symmetrically on the same plane.

6. The CD loading apparatus as claimed in claim 1, wherein said moveable clipping element is located at the front part of said base.

7. The CD loading apparatus as claimed in claim 1, wherein the central hole of said CD is outside of said base when said CD is ejected.
